(19) United States
(12) Patent Application Publication
(10) Pub. No.: US 2024/0034887 A1
(43) Pub. Date: Feb. 1, 2024

(54) COMPOSITION

(71) Applicants: Callum Stewart, Hong Kong (CN); Linxian Li, HongKong (CN)

(72) Inventors: Callum Stewart, Hong Kong (CN); Linxian Li, HongKong (CN)

(21) Appl. No.: 18/264,265

(22) PCT Filed: Feb. 4, 2022
(86) PCT No.: PCT/GB2022/050305

§ 371 Date: Aug. 4, 2023

(30) Foreign Application Priority Data
Feb. 4, 2021 (GB) 2101553.2

(51) Int. Cl. C09D 5/16; C08J 7/04; C09D 127/12; C09D 183/08; C09D 175/02; C09D 183/04; C08J 3/24

(52) U.S. Cl. CPC C09D 5/1687; C08J 7/0427; C09D 5/1675; C09D 5/1668; C09D 127/12; C09D 183/08; C09D 175/02; C09D 183/04; C08J 3/246; C08J 2367/02; C08J 2427/12; C08J 2483/08; C08J 2475/02; C08J 2483/04

(57) ABSTRACT

The present invention relates to a formulation technology that forms an omniphobic, slippery gel coating The formulation technology makes use of the cross-linking between two hydrophobic polymer reagents, solvated in a hydrophobic polymer lubricant, as they are combined and deposited on a substrate.

### FIELD OF INVENTION

The present invention relates to a formulation technology that forms an omniphobic, slippery gel coating. The formulation technology makes use of the cross-linking between two hydrophobic polymer reagents, solvated in a hydrophobic polymer lubricant, as they are combined and deposited on a substrate.

As the hydrophobic polymer reagents cross-link the liquid lubricant is encapsulated in the rapidly forming gel-matrix and is retained therein through non-covalent entrapment and covalent bonds.

The omniphobic coating of the present invention can be deposited on medical implants to prevent biological fouling and immune reactions, as an anti-icing and/or self-cleaning surface, on the inner surfaces of food and drink containers, and in pipes of varying diameter to facilitate fluid transfer and reduce cleaning requirements.

### BACKGROUND OF THE INVENTION

Omniphobic surfaces are a relatively recent development based on the surface properties of the Pitcher plant of the genus Sarracenia, Nepenthes and Darlingtonia. The field is derived from the development of lotus-like superhydrophobic surfaces. The original slippery liquid-infused porous surfaces (SLIPS) are complex structures involving re-entrant and micropillar topologies, chemical modification, and lubricant infusion. The combined surface structures and chemical modifications allow for preferential lubricant retention when exposed to another incoming liquid, resulting in the incoming liquid being repelled.

From their unique properties, omniphobic surfaces have potential to be used in a wide variety of applications.

For example, thrombosis is a recurring problem in cardiovascular stents due to the attachment and denaturation of biomolecules on the inner surface of stents, resulting in an immune response. The inside surfaces of most stents are coated with heparin to reduce this, but the effect of heparin is depleted as the heparin is desorbed after implementation. Superhydrophobic coatings extend the lifetime of the stents but still result in protein denaturation due to eventual loss in hydrophobicity. This is theorized as being due to the surface slowly becoming coated in denatured hydrophobic biomolecules, and thus, inducing thrombosis and related immune responses.

Similarly, bacterial biofilms can form during the insertion of temporary medical devices, e.g. catheters. Omniphobic coatings in particular can greatly lessen the attachment of protein and bacteria on the stents and other medical devices, and thereby reduce the surgeries, medication, and patient discomfort.

Omniphobic coatings can reduce drag on the inner surfaces of pipes of various size, allowing more effective transportation of fluids and improve the infrastructure. Omniphobic coatings can also be used on the inside of various sized containers for water and oils to prevent fouling and protect the vessel. Accordingly, the maintenance need can be reduced and the lifetime of the equipment increased. Therefore, omniphobic coatings can also be used for more efficient liquid transfer through pipes with varying diameters, e.g. waste disposal (plumbing), fuel lines in engines, or medical catheters.

Most of the currently known omniphobic surfaces require extensive processing for achieving the required surface structures and chemistry as well as an additional lubricant infusion step.

One known approach for making omniphobic surfaces is through immobilised liquids, wherein the surface is first coated with a molecular polymer surface layer and after which they are infused with lubricants. This method of creating coatings is referred to herein as a two-step process.

A more developed chemical approach is referred to as slippery omniphobic covalently attached liquids (SOCALs), which are surface modifications with long polymer brush chains designed to create the ‘liquid-like’ effect of slippery lubricant infused porous substrates (SLIPS). However, the SOCAL synthesis process requires a significant quantity of liquid chemicals necessitating disposal.

Nanoparticle coatings have also been used to create omniphobic coatings. They have a benefit over typical immobilised liquids and SOCALs as they incorporate surface topology, as well as the potential for application to various substrates with multiple pre-existing industrial techniques, such as spray or dip coating. However, these methods also require a further lubricant infusion step.

All of these processes are lengthy, expensive, and produce a significant amount of waste products.

The present invention overcomes the above-mentioned problems by providing a composition that imparts omniphobic properties, wherein the composition contains components that cross-link under reaction enabling conditions to arrive at a film-forming/coating composition based on a cross-linked matrix of hydrophobic polymers that entraps a hydrophobic polymer solvent component, wherein the components used to form the film-forming/coating composition are such that allow the composition to be prepared in a single-step under ambient conditions. That is to say the method for preparing the films/coatings is a one-step process which is more efficient than the previously known two-step processes.

The incorporation of the lubricants, particularly low surface tension lubricants, such as perfluoro oils (e.g. Krytox™) or Polydimethylsiloxane, results in the omniphobic interface (lubricant-liquid) as opposed to a superhydrophobic (solid-liquid) interface.

### BRIEF DESCRIPTION OF THE INVENTION

According to a first aspect of the invention, there is provided a composition comprising: a cross-linkable hydrophobic polymer component comprising at least three nucleophilic groups;
a cross-linking hydrophobic polymer agent comprising at least two electrophilic groups that cross-links with the cross-linkable component under reaction enabling conditions; and
a hydrophobic polymer lubricant component;
wherein the cross-linkable hydrophobic polymer component and the cross-linking hydrophobic agent are present in the composition in an amount so as to provide a molar ratio of nucleophilic groups to electrophilic groups of 9:1 to 1:9.

According to a second aspect of the invention there is provided a coated article comprising:
(a) a substrate; and
(b) a composition according to the first aspect of the invention coated on a surface of the substrate.

According to a third aspect of the invention there is provided a method of preparing a coated article comprising the steps of:
providing an article comprising a substrate and at least one surface; and
applying a composition according to the first aspect of the invention to the surface of the substrate, wherein the electrophilic groups on the cross-linking hydrophobic polymer agent react with the nucleophilic groups of the cross-linkable hydrophobic polymer component to provide a cross-linked coating.

According to a fourth aspect of the invention there is provided a kit-of-parts comprising:
(a) a first solution comprising a cross-linkable hydrophobic polymer component in a hydrophobic polymer lubricant, wherein the cross-linkable hydrophobic polymer component comprises at least three nucleophilic groups; and
(b) a second solution comprising a cross-linking hydrophobic polymer agent in a hydrophobic polymer lubricant, wherein the cross-linking hydrophobic polymer agent comprises at least two electrophilic groups,
wherein the cross-linkable hydrophobic polymer component is present in the first solution and the cross-linking hydrophobic agent is present in the second solution in an amount so as to provide a molar ratio of nucleophilic groups to electrophilic groups of 9:1 to 1:9.

According to a fifth aspect of the invention there is provided the use of a composition according the first aspect of the invention for coating a substrate.

According to a sixth aspect of the invention there is provided a composition prepared by the method according to the third aspect of the invention.

### DEFINITIONS

Unless otherwise indicated, all technical and scientific terms used herein have the same meaning as commonly understood by one of ordinary skill in the art to which this invention pertains.

It must be noted that, as used in this specification and the appended claims, the singular forms “a,” “an,” and “the” include plural referents unless the context clearly dictates otherwise.

As used herein, the term “comprises” will take its usual meaning in the art, namely indicating that the component includes but is not limited to the relevant features (i.e. including, among other things). As such, the term “comprises” will include references to the component consisting essentially of the relevant substance(s).

For the avoidance of doubt, the term “comprises” will also include references to the component “consisting essentially of” or “consists essentially of” (and in particular “consisting of” or “consists of”) the relevant substance(s).

As used herein, unless otherwise specified the terms “consists essentially of” and “consisting essentially of” will refer to the relevant component being formed of at least 80% (e.g. at least 85%, at least 90%, or at least 95%, such as at least 99%) of the specified substance(s), according to the relevant measure (e.g. by weight thereof). The terms “consists essentially of” and “consisting essentially of” may be replaced with “consists of” and “consisting of”, respectively.

### BRIEF DESCRIPTION OF THE FIGURES

The embodiments of the invention, together with its advantages, may be best understood from the following detailed description taken in conjunction with the accompanying figures.

FIG. 1—schematic illustration of the method of preparing a coated article according to the invention.

FIG. 2—SEM image of unlubricated Fluorogel 1:3

FIG. 3—SEM images of 9:1 (a), 6:1 (b), 1:6 (c), and 1:9 (d) unlubricated Fluorogel coatings.

FIG. 4—Atomic force Microscopy (AFM) surface profile of a typical unlubricated Fluorogel coating.

FIG. 5—2-step lubricated fluorogel contact angles.

FIG. 6—2-step lubricated Fluorogel sliding angles.

FIG. 7—2-step lubricated Siligel Contact angles.

FIG. 8—2-step lubricated Siligel sliding angles.

FIG. 9—Unlubricated Fluorogel contact angles.

FIG. 10—Unlubricated Siligel contact angles.

FIG. 11—Unlubricated Fluorogel representative FTIR spectra.

FIG. 12—Unlubricated Siligel Representative FTIR spectra.

FIG. 13—1-step lubricated Fluorogel contact angles.

FIG. 14—1-step lubricated Fluorogel sliding angles.

FIG. 15—Contact angles of Krytox 103 infused 1:3 ratio Fluorogel coatings.

FIG. 16—Sliding angles of Krytox 103 infused 1:3 ratio Fluorogel coatings.

FIG. 17—1-step lubricated Siligel Contact angles.

FIG. 18—1-step lubricated Siligel sliding angles.

FIG. 19—Contact angles of OH-PDMS infused 1-step and 2-step siligel coatings.

FIG. 20—Sliding angles of OH-PDMS infused 1-step and 2-step siligel coatings.

FIG. 21—MDA-MB-468 and HEK 293 cell proliferation on Untreated TCP, 1:3 Fluorogel (Composition 1 of Table 1) and 1:3 Siligel (Composition 2 of Table 1) (Lubricated and Unlubricated).

### DESCRIPTION OF THE INVENTION

The invention should not be construed as being limited to any of the following embodiments or any of the features described in these embodiments except to those features present in the independent claims. Furthermore, it is envisaged that all features in the embodiments may be combined with other features in other embodiments where appropriate and reasonably plausible.

### Composition

In the first aspect of the invention there is provided a composition comprising:
a cross-linkable hydrophobic polymer component comprising at least three nucleophilic groups;
a cross-linking hydrophobic polymer agent comprising at least two electrophilic groups that cross-links with the cross-linkable component under reaction enabling conditions; and
a hydrophobic polymer lubricant component;
wherein the cross-linkable hydrophobic polymer component and the cross-linking hydrophobic agent are present in the composition in an amount so as to provide a molar ratio of nucleophilic groups to electrophilic groups of 9:1 to 1:9.

The composition of the first aspect of the invention is herein referred to as the composition of the invention.

Preferably, the cross-linkable hydrophobic polymer component and the cross-linking hydrophobic polymer agent are present in the composition in an amount so as to provide a molar ratio of nucleophilic groups to electrophilic groups of 9:1 to 1:9, such as 5:1 to 1:5 or 3:1 to 1:3.

The term “molar ratio” used herein may be referred to interchangeably by the term “stoichiometric ratio”. That is to say, where the cross-linkable hydrophobic polymer component and the cross-linking hydrophobic agent are present in the composition in an amount so as to provide a molar ratio of nucleophilic groups to electrophilic groups of 9:1, this means that for every 9 moles of nucleophilic groups present on the cross-linkable hydrophobic polymer component there is 1 mole of electrophilic groups present on the cross-linking hydrophobic agent. In stoichiometric terms, this would also arrive at a composition where there are 9 nucleophilic groups for 1 electrophilic group.

For the avoidance of doubt, the molar/stoichiometric ratio is based on the electrophilic and nucleophilic groups present on the cross-linkable hydrophobic polymer component and the cross-linking hydrophobic polymer agent only. The molar/stoichiometric ratio does not take into account any other electrophilic or nucleophilic groups present in the composition due to the incorporation of other components, for example the hydrophobic polymer lubricant.

Advantageously, the cross-linkable hydrophobic polymer component comprises from 3 to 10 nucleophilic groups, such as from 3 to 5 nucleophilic groups, for example 3 nucleophilic groups.

Conveniently, the cross-linking hydrophobic polymer agent comprises from 2 to 5 electrophilic groups, such as 2 to 3 electrophilic groups, for example 2 electrophilic groups.

Preferably, the nucleophilic groups on the cross-linkable hydrophobic polymer component are amine groups.

Advantageously, the electrophilic groups on the cross-linking hydrophobic polymer agent are isocyanate groups.

Conveniently, the cross-linkable hydrophobic polymer component has a molecular weight of from 5,000 to 25,000, for example from 5,000 to 15,000, such as from 10,000 to 13,000.

Preferably, the cross-linking hydrophobic polymer agent has a molecular weight of from 2,000 to 10,000, such as from 4,000 to 9,000.

Advantageously, the cross-linkable hydrophobic polymer component has a viscosity at 25° C. of from 100 to 1000 cps, such as from 300 to 700 cps.

Conveniently, the cross-linking hydrophobic polymer agent has a viscosity at 25° C. of from 30 to 75,000 cps, for example from 30 to 50,000 cps, such as from 100 to 20,000 cps, for example from 500 to 5000 cps, such as from 1000 to 3500 cps.

Advantageously, the hydrophobic polymer solvent has a viscosity at 25° C. of from 50 to 500 cps, such as from 50 to 200 cps, for example from 50 to 150 cps.

Preferably, the cross-linkable hydrophobic polymer component and/or the cross-linking hydrophobic polymer agent is a silicone, a perfluoro poly(ether) or a derivative thereof.

Conveniently, the hydrophobic polymer lubricant is non-volatile.

Advantageously, the hydrophobic polymer lubricant is a low surface tension lubricant having a surface tension of from 10 to 40 milliNewtons per meter (mN/m), such as 12 to 35 mN/m, for example from 14 to 25 mN/m.

A low surface tension results from liquids that have weak interactions with themselves (cohesive forces) where the liquid contacts the air. The low surface tension lubricants are largely, but not exclusively, chemically inert/stable. For example, the surface tension of silicone oil is approximately 21-22 mN/m, while Krytox™ oils have been reported at surface tensions of 17 mN/m, and perfluoro polyethers have reported values of 14-25 mN/m.

Advantageously, the hydrophobic polymer lubricant is selected from the list consisting of polyols, silicone oils, perfluoro poly(ethers), and mixtures thereof.

In the embodiment wherein the hydrophobic polymer lubricant comprises a nucleophile, such as wherein the lubricant is a polyol, preferably the at least three nucleophilic groups on the hydrophobic polymer component are stronger nucleophiles than the nucleophile(s) of the hydrophobic polymer lubricant.

Conveniently, the cross-linkable hydrophobic polymer component is present in the composition in an amount of from 0.01 to 10 wt. %, such as from 0.03 to 10 wt. %, for example from 0.1 to 5 wt. %, such as from 0.2 to 5 wt. %, for example 0.2 to 1 wt. %.

Preferably, the cross-linking hydrophobic polymer agent is present in the composition in an amount of from 0.1 to 10 wt. %, such as from 0.2 to 8 wt. %, for example from 0.5 to 6 wt. %, such as from 1 to 2 wt. %.

Advantageously, the hydrophobic polymer lubricant component is present in the composition in an amount of from about 70 wt. % to about 99.9 wt. %, such as from about wt. % to about 99.5wt. %, for example from 85 to 99.5 wt. %, such as from 90 to 99.2 wt. %, for example from 96 to 99 wt. %.

In respect of the percentages of the components of the composition, unless otherwise indicated this is a reference to their percentage by weight of the combined weight of the components in the composition. In other words, each percentage represents the total amount of the corresponding component present in the composition.

The skilled person will understand that, by virtue of their amounts being defined as a percentage this does not necessarily mean that the positively defined components in the composition of the invention must total 100% as other, non-defined, components may be present. Indeed, the presence of further non-defined components is envisaged as long as the composition provides its intended function.

Further, the skilled person will understand the term “about” to mean within a reasonable degree of accuracy of the amount indicated. For example, where a percentage is indicated as a whole number, this may include amounts that correspond to said amount when rounded up or down (as appropriate) to the nearest whole number. Moreover, where a percentage is indicated to one decimal place, this may include amounts that correspond to said amount when rounded up or down (as appropriate) to a value indicated to one decimal place. As such, the term “about” may be deleted from definitions provided herein without changing the meaning of the respective definition.

As outlined above, the composition of the invention has been advantageously shown to coat the surfaces of substrates and spontaneously cross-link under ambient conditions to provide an omniphobic coating to the surface, meaning that the compositions may be film-forming.

By the term “ambient conditions” as used herein, this refers to the components cross-linking at normal (e.g. room) temperature and pressure, or in the range thereof.

Preferably, the components cross-link at a temperature from 0° C. to 60° C., for example from about 10° C. to 50° C., such as from 15° C. to 40° C.

Advantageously, the components cross-link at a pressure of from 50 to 150 kPa, such as from 75 to 125 kPa.

By the term “omniphobic coating” as used herein, this means that the coating formed by the composition of the invention is repellant to all liquids, for example both polar and non-polar liquids. Put another way, an omniphobic coating is both hydrophobic and oleophobic.

Therefore, in an embodiment the composition of the invention can be in the form of a cross-linked omniphobic composition, such as an omniphobic coating or film. Such a coating or film can be present on the surface of a substrate.

Preferably, the omniphobic composition, coating, or film has a water contact angle greater than about 30°, such as greater than about 40°, 50°, 60 or 70°, for example from 40° to 120°, such as from 45° to 90°, for a 5 μL water droplet.

Advantageously, the omniphobic composition, coating, or film has an oil contact angle of greater than about 30°, such as greater than about 40°, for example from 40° to 120°, such as from 40° to 70°, for a 5 μL water droplet.

Conveniently, the omniphobic composition, coating, or film has a water sliding angle greater than about 1°, such as greater than about 2°, 3°, 4 or 5°, for example from 2° to 20°, such as from 5° to 20°, for a 20 μL water droplet.

Preferably, the omniphobic composition, coating, or film has a water sliding angle greater than about 1°, such as greater than about 2°, 3°, 4 or 5°, for example from 2° to 20°, such as from 5° to 20°, for a 20 μL water droplet.

### Coated Articles

The composition of the first aspect of the invention is useful for the depositing on the surface of substrates to form omniphobic coatings.

The inventors have surprisingly found that the following benefits are provided by the present invention:
The application of these coatings in the medical field can reduce negative immune reaction from long term implants (e.g. thrombosis in cardiovascular stents) and temporary implants, i.e. catheter tubes.
The omniphobic coatings are more repellent of water and would allow for more efficient transfer for both fresh water and waste management, when used on pipes.
Additionally, these coatings are repellent of more complex solutions, emulsions, etc, while being biocompatible, and thus, would provide superior transfer of numerous foodstuffs and other complex mixture when applied to containers or packaging.
Improved transfer and waste removal would reduce the water demand of a city, thereby, making the region more sustainable.
Implementing these coatings into a product would only add one step at the end of the overall manufacturing process. The current cost of applicable chemicals is quite low per unit volume and would further drop as the chemical company grows to meet demand, also increasing the employee numbers accordingly.

Therefore, in a second aspect of the invention there is provided a coated article comprising:
(a) a substrate; and
(b) a composition of the invention coated on a surface of the substrate.

Preferably, the substrate is selected from the group consisting of plastics, glass, metal and ceramics.

Advantageously, the composition coated on the surface of the substrate has a thickness of from 50 nm to 1 mm.

The coatings of the present invention can also be applied to transparent surfaces for repellent applications, such as anti-icing and self-cleaning of glass panels and mirrors, or for biological research applications, such as for coating cell culture equipment of microfluidic equipment.

Conveniently, the coated article is selected from the list consisting of:

Pipes and sealed containers (for example for water or oil transportation), toilets, sinks, ceramic surfaces, food and/or liquid containers, catheters, syringe chambers, medical tubing, stents, catheters, peristatic pump tubing implants, face shields, operating goggles, cell expansion petri dishes, disposable labware, mirrors, shower screen paneling, glasses, safety goggles, swimming goggles and diving masks.

### Method for Preparing Coated Articles

According to a third aspect of the invention there is provided a method of preparing a coated article comprising the steps of:
providing an article comprising a substrate and at least one surface; and
applying a composition of the invention to the surface of the substrate, wherein the electrophilic groups on the cross-linking hydrophobic polymer agent react with the nucleophilic groups of the cross-linkable hydrophobic polymer component to provide a cross-linked coating.

The method of the invention uses a cross-linkable hydrophobic polymer component comprising at least three nucleophilic groups and a cross-linking hydrophobic polymer agent comprising at least two electrophilic groups that cross-links with the cross-linkable component under reaction enabling conditions to produce a polymer matrix. The two reagents are solvated in a hydrophobic polymer lubricant component in a single-step process.

The mixture can then be rapidly deposited on the substrate where the electrophilic groups react spontaneously with the nucleophilic groups, with the lubricant being directly incorporated into the polymer matrix producing the omniphobic coatings.

For the avoidance of doubt, the composition may comprise any of the features as outlined above for the composition of the invention. Furthermore, the substrate may comprise any of the features as outlined above in the second aspect of the invention.

Preferably, the composition is prepared by:
providing a first solution comprising the cross-linkable hydrophobic polymer component in the hydrophobic polymer lubricant;
providing a second solution comprising the cross-linking hydrophobic polymer agent in the hydrophobic polymer lubricant; and
mixing the first and second solutions prior to applying to the surface of the substrate.

Advantageously, the first and second solution are homogenized before applying to the surface of the substrate.

Conveniently, the composition is applied to the surface of the substrate within 300 seconds of mixing the first and second solutions, such as within 5 to 300 seconds.

Preferably, in the first solution the cross-linkable hydrophobic polymer component is present in an amount of from 0.1 to 40 wt. %, such as from 0.5 to 37 wt. %, for example from 1 to 10 wt. %, such as from 1 to 6 wt. %, and wherein the hydrophobic polymer lubricant is present in an amount of from 60 to 99.9 wt. %, such as from 63 wt. % to 99.5 wt. %, for example from 90 to 99 wt. %, such as from 94 to 99 wt. %.

Advantageously, in the second solution the cross-linking hydrophobic polymer agent is present in an amount of from 0.1 to 20 wt. %, for example from 0.5 to 15 wt. %, such as from 1 to 5 wt. %, for example from 1 to 3 wt. %, and wherein the hydrophobic polymer lubricant is present in an amount of from 80 to 99.9 wt. %, for example from 85 wt. % to 99.5 wt. %, such as from 95 to 99 wt. %, for example from 97 to 99 wt. %.

For the avoidance of doubt, after mixing the first and second solutions together this arrives at the composition of the invention.

Conveniently, the composition is applied to the surface of the substrate at a temperature of from 0° C. to 60° C., for example from about 10° C. to 50° C., such as from 15° C. to 40° C.

Preferably, the substrate is selected from the group consisting of plastics, glass, metal and ceramics.

Advantageously, the composition coated on the surface of the substrate has a thickness of from 50 nm to 1 mm.

The inventors have found that with a surface coating of less than 50 nm thick, not enough lubricant will be held to impart the omniphobic properties and over 1 mm introduces too much substrate roughness and internal sheer.

Conveniently, the article is selected from the list consisting of:
Pipes and sealed containers (for example for water or oil transportation), toilets, sinks, ceramic surfaces, food and/or liquid containers, catheters, syringe chambers, medical tubing, stents, catheters, peristatic pump tubing implants, face shields, operating goggles, cell expansion petri dishes, disposable labware, mirrors, shower screen paneling, glasses, safety goggles, swimming goggles and diving masks.

The method of the invention is advantageous due to the fact that as the composition is deposited on the substrate where they undergo a rapid, spontaneous reaction to produce omniphobic coatings. The rapid synthesis method traps the lubricant within the coating, which eliminates the need for a lubricant infusion step. The same coatings can be produced via a two-step version. These coatings are not only produced very quickly, but also result in very little waste products.

Additionally, the coatings are soft and flexible, making them perfect for substrates that undergo movement. This technology can be scaled into industrial applications, as the coating can be a final step in the manufacturing process. Additionally, the formulation technology of the present invention utilize currently existing deposition techniques, i.e. a fine spray nozzle head, which are widely used when applying a coating of paint.

Therefore, in an embodiment the composition may be applied by spraying onto the substrate, wherein the components of the composition are mixed prior to spraying, or wherein the components are mixed whilst simultaneously being sprayed, or they are mixed on the surface of the substrate itself.

Advantageously, after applying the composition it is allowed to cross-link on the surface of the substrate for up to 300 seconds, for example from 5 to 300 seconds before the composition is removed/allowed to drain.

Conveniently, after cross-linking the excess composition is allowed to run-off the surface of the substrate and can be reused for a second surface.

### Kit-of-Parts

According to a fourth aspect of the invention there is provided a kit-of-parts comprising:
(a) a first solution comprising a cross-linkable hydrophobic polymer component in a hydrophobic polymer lubricant, wherein the cross-linkable hydrophobic polymer component comprises at least three nucleophilic groups; and
(b) a second solution comprising a cross-linking hydrophobic polymer agent in a hydrophobic polymer lubricant, wherein the cross-linking hydrophobic polymer agent comprises at least two electrophilic groups,
wherein the cross-linkable hydrophobic polymer component is present in the first solution and the cross-linking hydrophobic agent is present in the second solution in an amount so as to provide a molar ratio of nucleophilic groups to electrophilic groups of 9:1 to 1:9.

The first and second solution in the kit-of-parts may comprise any of the features of the first and second solutions in any other aspect of the invention as detailed herein.

### Use of the Composition

According to a fifth aspect of the invention there is provided the use of a composition according to the first aspect of the invention for coating a substrate.

The substrate may comprise any of the features of the substrate in any other aspect of the invention as detailed herein.

### EXAMPLES

The present invention will be further described by reference to the following examples which are not intended to limit the scope of the invention.

The methods below use bi-terminated isocyanate polymers in combination with a branched polyamine to produce a polyurea polymer matrix. The two reagents are solvated in the poly-alcohol (polyol) lubricant in the single-step process. The mixture is then rapidly deposited on the substrate where the isocyanates react spontaneously with the polyamines. The polyol lubricant is directly incorporated into the polymer matrix producing the omniphobic coatings.

### Example 1

### Synthesis of Omniphobic Coatings

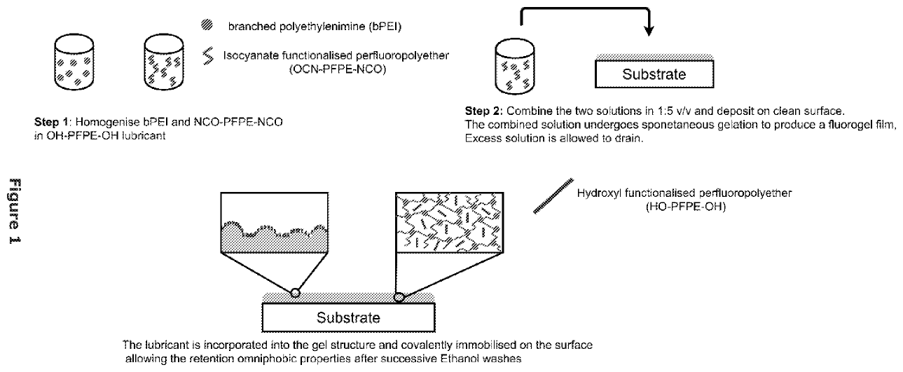

Siligel was synthesised using the 1-step process described above and depicted in FIG. 1. Silmer NCO Di-100 (Sil-NCO, Siltek, liner di-functional isocyanate-terminated silicone pre-polymer) and Silmer NH C50 (Sil-NH, Siltek, tri-functional silicone with reactive amine groups) were homogenised in a solvating PMX-200 silicone oil (Xiameter) at varying concentrations to produce a coating mixture with molar ratios of NH: NCO ranging from 5:1 (Sil-NH=0.05 mg, Sil—NCO=0.007 mg, Si oil=1 mg)−1:5 (Sil—NH=0.01 mg, Sil-NCO=Si oil=1 mg). For example, to produce a coating with a 1:3 molar ratio, 0.05 g/mL Sil—NH and 0.02 g/mL Sil—NCO solutions were combined in a Eppendorf tube at a 1:5 volume ratio, respectively, producing a combined solution of Sil—NH=0.01 mg, Sil—NCO=0.02 mg, Si oil=1 mg. The combined solution was deposited on a clean glass slide until the entire surface was covered and removed after a few seconds before standing on end to drain overnight.

The siligel coating was also deposited on cleaned Polyethylene terephthalate (PET) bottles, Nylon tubing, and tissue culture plates with a slight increase in exposure time to ensure uniform deposition.

### Example 2

### Synthesis of Omniphobic Coatings

Fluorogel was synthesised using the 1-step process described above and schematically illustrated in FIG. 1. This process was observed for a 1:3 ratio fluorogel coating. NCO-PFPE (isocyanate-perfluoro poly(ether)) (FluorN 1788 Cytronix) and bPEI (branched polyethylene amine) (#408719-Merck) were solvated in a OH-PFPE (hydroxy-perfluoro poly(ether)) (FluorN1017 Cytronix) lubricant at concentrations of 0.033 g/mL and 0.02 g/mL, respectively. 0.2mL of the bPEI/OH-PFPE solution was combined with 1 mL of the NCO-PFPE/OH-PFPE solution (1:5 volume ratio) to produce a final solution containing bPEI, 0.033 g NCO-PFPE, and 1 g of OH-PFPE. The solution was deposited on a clean glass slide until the entire surface was covered and removed after a few seconds before standing on end to drain overnight.

The fluorogel coating was also deposited on cleaned Polyethylene terephthalate (PET) bottles, Nylon tubing, and tissue culture plates with a slight increase in exposure time to ensure uniform deposition.

### Comparative Example 3

### Unlubricated and 2-Step Coatings

The fabrication of water and oil repellent coatings (herein called omniphobic) via a spontaneous, single-step synthesis has been describe above in examples 1 and 2. The same reactions can be applied in a two-step alternative process. In the unlubricated and two-step reaction processes, the isocyanates and polyamines are solvated in a rapidly evaporating organic solvent (e.g. pure ethanol) instead of perfluoro or silicone lubricant. The ethanol mixtures (outlined in table 1) are deposited on the substrate and allowed to evaporate, leaving behind the unlubricated polyurea matrix coating. To produce the 2-step coatings from the unlubricated, the lubricant is then deposited on the surface and allowed to infuse into the polymer matrix as required. These coatings were synthesised for examination of physicochemical properties of the omniphobic coatings due to instrument limitations (such as low pressure, vacuum conditions) and for comparison to the 1-step synthesis coating counterparts.

The Fluorogel coatings utilise a bi-terminated isocyanate and a bi-terminated hydroxy Perfluoro Polyether (PFPE) from Cytronix (USA) in conjunction with branched polyethyleneimine (bPEI) from Sigma-Aldrich, now Merck. The PFPE compounds have been verified as EU-regulation compliant. The Silicone variant makes use of a bi-terminated isocyanate and branched polyamine silicone pre-polymer from SilTech (Canada) and unfunctionalized Silicone oil (Xiameter PMX 200, 100 cSt).

### Experimental Information:

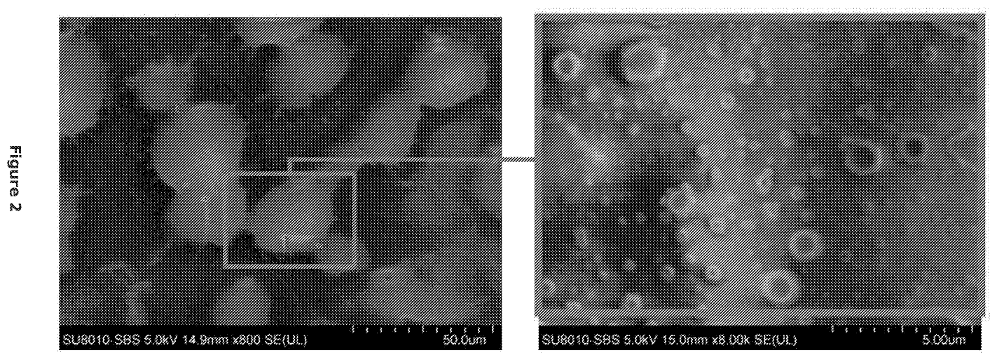

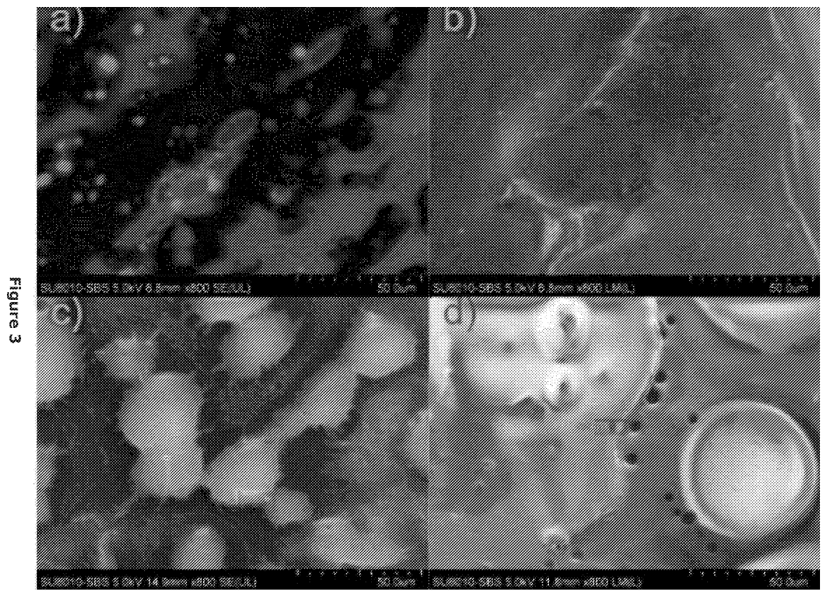

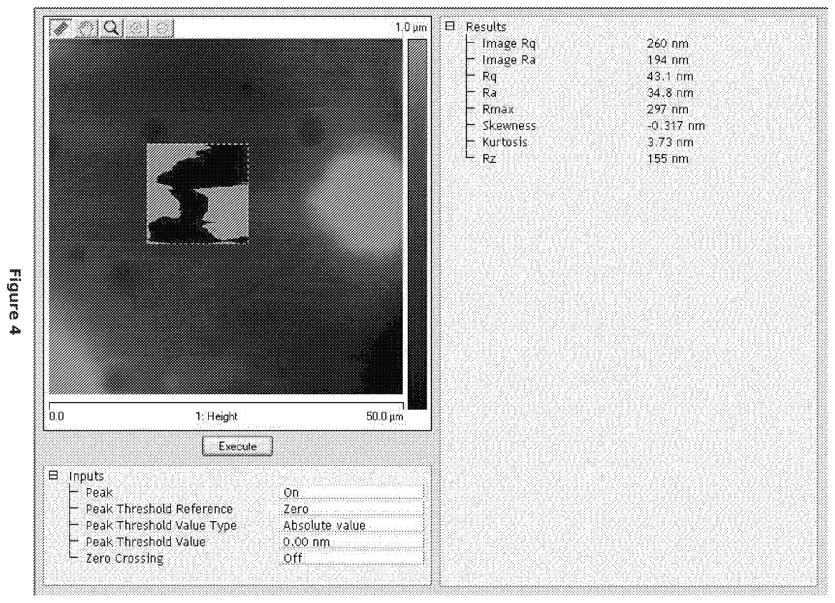

Surface imaging and chemical analysis were performed by SEM (Scanning Electron Microscopy) and EDX (Energy Dispersive X-Ray Analysis), respectively, while preliminary roughness measurements were performed with AFM (Atomic Force Microscopy). The SEM showed raised island topology with shallow open pores. The size of these features was depended on the molar ratio between the PFPE and bPEI. The coincidental island structures across the fluorogel surfaces resemble the micropillars found on other omniphobic SLIPS, while the ring structures resemble those observed in nature for water repellence (FIGS. 2 and 3). The surface roughness was difficult to measure using AFM due to the soft gel nature of the coatings, but preliminary testing suggests that the average roughness of the Fluorogel coatings were 100-200 nm (FIG. 4). The EDX showed that the surface fluorine concentration ranged from 28.2±1% to 37±1%, with the corresponding carbon concentrations of 45.7±0.6% and 34.6±0.5%. The SEM, AFM, and EDX results shown are representative. The SEM and chemical composition of the unlubricated Siligels can be found in example 4.

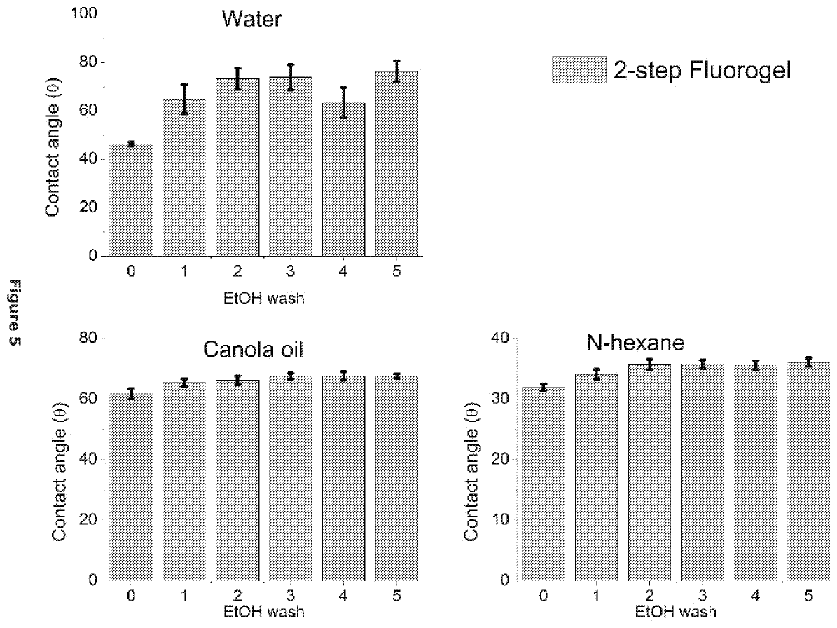

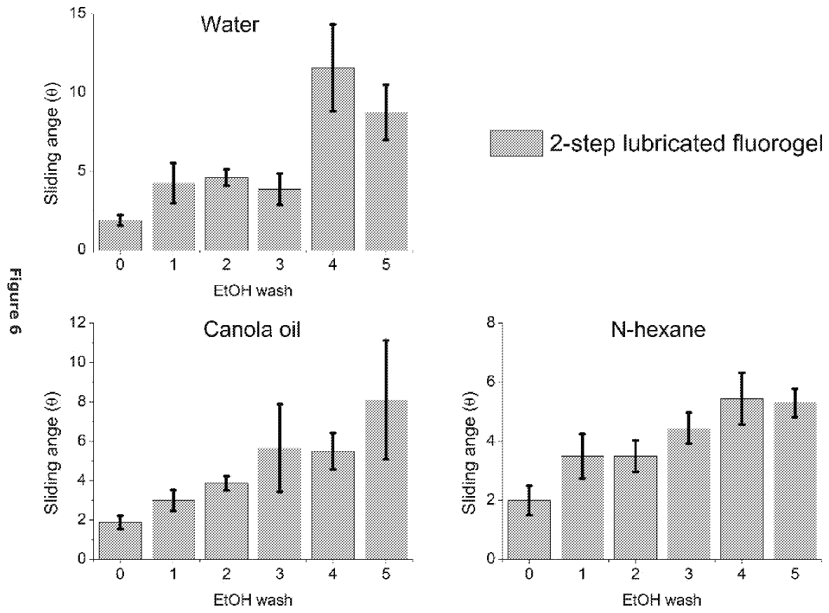

The Contact and sliding angles of the Fluorogel omniphobic coatings were measured using water, canola oil, and n-hexane. The coatings were measured and washed in pure ethanol to remove the surface lubricant layer, then allowed to recover for 24 hours before the next measurements. No significant differences were observed between the single-step and two-step Fluorogel fabrication processes. The contact angles show that the n-hexane was consistent across all washes, the canola oil increased from 50-55° to 60-65°, and water increased from ˜50° to ˜75-80° (FIG. 5). The sliding angles were largely depended on the amount of lubricant, as per the washes, with initial sliding angles initially 2-4° to a maximum of 10-15° by the end of the washing cycle (FIG. 6). These sliding and contact angles were unaffected after a month's storage in air, phosphate buffer solution, and cell media.

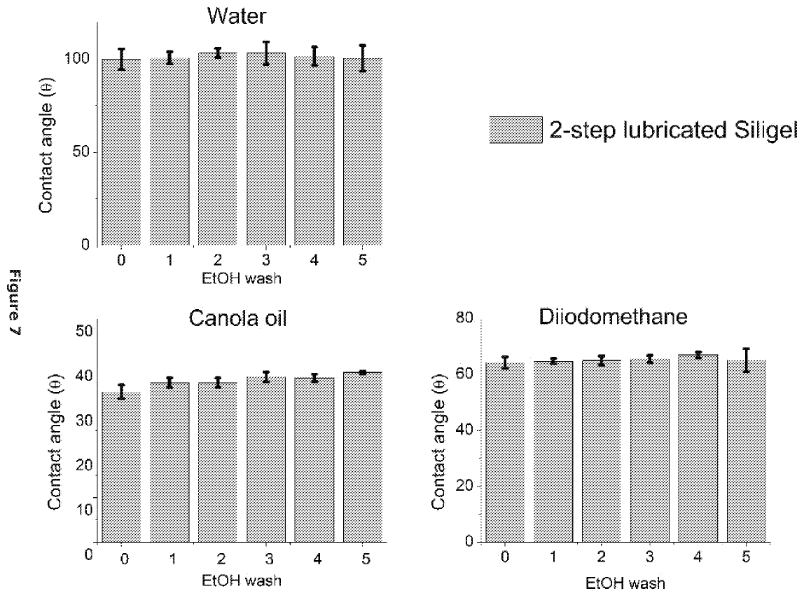

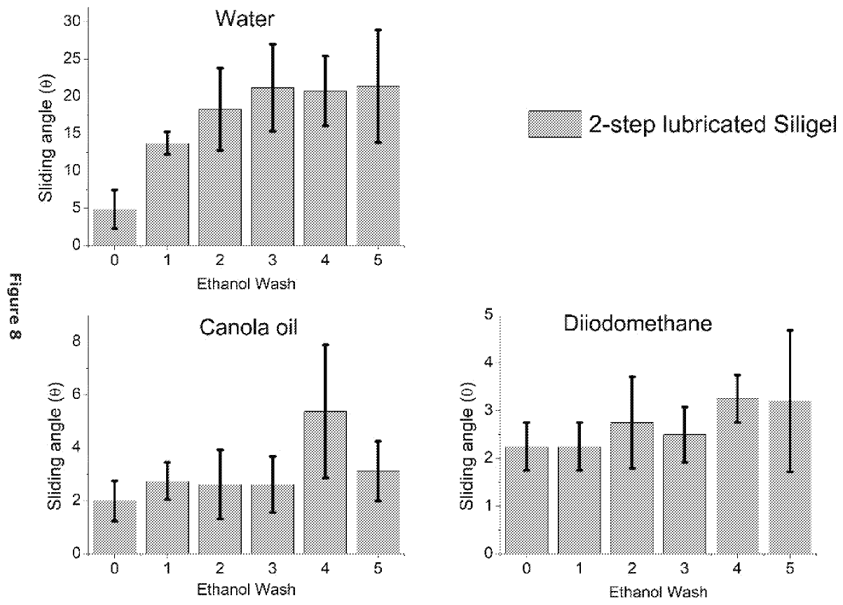

The contact and sliding angles of the 2-step 1:3 Siligel omniphobic coatings. The Contact angles were consistent with the 1-step siligel coating. However, the sliding angles show minimal retention of sliding capacity, thus suggesting that the direct incorporation of the silicone oil via our one-step synthesis is required. (FIGS. 7 and 8).

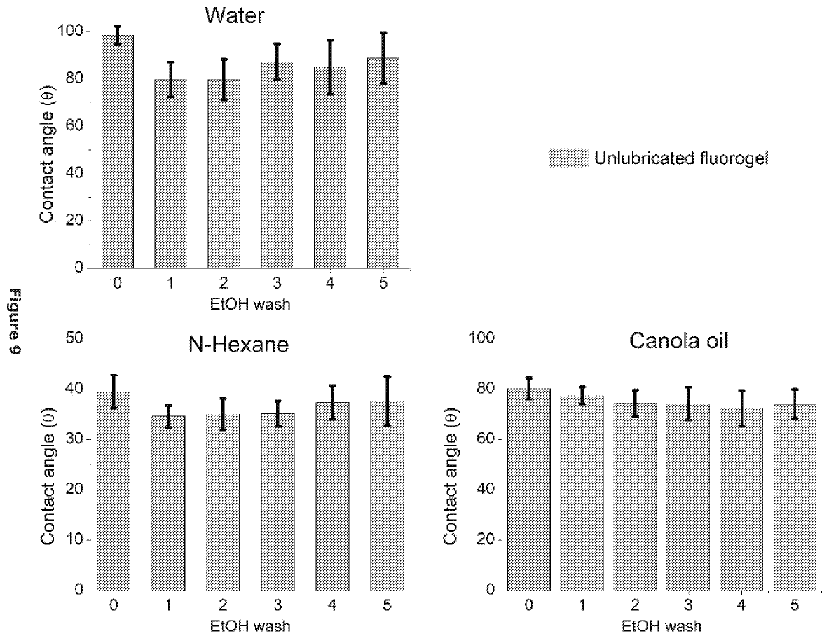

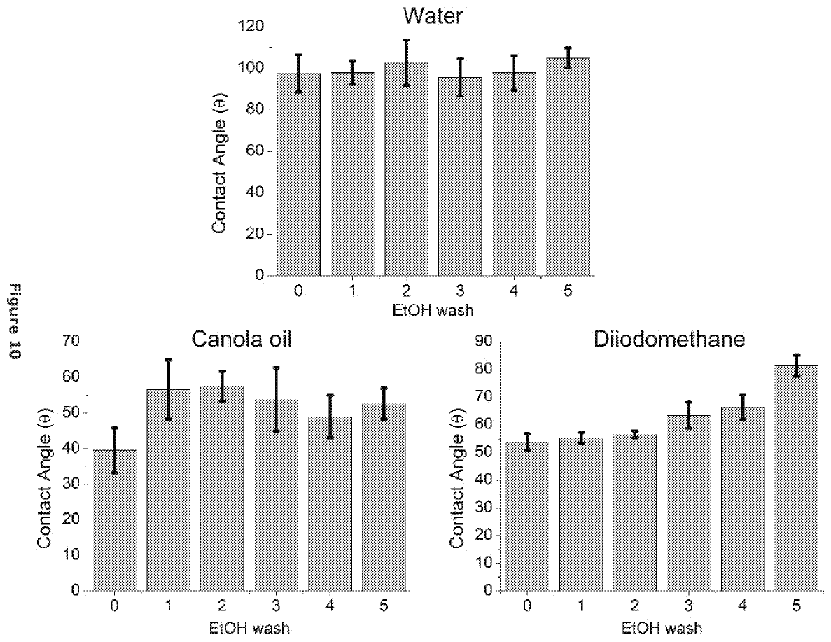

The EtOH solvated unlubricated versions of the Fluorogel and Siligel were examined for comparison (the 2-step coating without lubricant infusion). The Fluorogel coatings were found to be liquid pinning up to a complete 180° inversion. The contact angles were found to be predominately static for Canola oil and N-hexane, at approximately 80° and 40° respectively. The water contact angles were found to stabilise around 80-90°, depending on the surface fluorine concentration, as represented by the bPEI: NCO-PFPE molar ratio (FIG. 9). The Siligel coatings demonstrated consistent static contact angles within variation regardless of the number of EtOH washes and molar ratio composition. Water CAs were found to be between 90°-100°, Canola oil around 37°-40°, and MeI fluctuated around 65°-70°, which are consistent with previous literature (FIG. 10).

### Comparative Example 4

### Synthesis of Omniphobic Coatings

A liquid polydimethylsiloxane (PDMS) with OH terminal groups (Alfa Aeser, USA) variant was synthesised via the via the 1-step and 2-step procedures outlined above in section (x), by replacing the Xiameter PMX 200 silicone oil with the stated PDMS liquid polymer. A Krytox 103 oil (DuPont) variant of the Fluorogel was also synthesized using the established 1-step and 2-step methodologies, by replacing the OH-PFPE with stated Krytox 103 lubricant.

Unlubricated versions of the Fluoro and Siligel using EtOH as the solvent were synthesised for comparison using the 1-step process described above. These unlubricated coatings could then be infused with the respective lubricants to reproduce the standard 2-step process. The high evaporative nature of EtOH allowed for the instant formation of the underlying polymer matrices. Static omniphobicity was observed but droplet sliding was not due to the absence of lubricant oil.

The solutions were deposited on a clean glass slide until the entire surface was covered and removed after a few seconds before standing on end to drain overnight.

TABLE 1
Initial and Final solution wt % (Init./Fin.) for Fluorogel and Siligel coatings

| | | | Silicone | | | | |
|---|---|---|---|---|---|---|---|
| | | | oil | | | | NH:NCO |
| | Sil-NCO | Sil-NH | (wt. %, | NCO-PFPE | bPEI | OH-PFPE | ratio, |
| Composition | (wt. %) | (wt. %) | Fin.) | (wt. %) | (wt. %) | (wt. %) | Fin. |
| 1 - Fluorogel 1:3 | | | | 2.23/1.85 | 1.47/0.24 | 97.8 | 1:3 |
| 2 - Siligel 1:3 | 2.1/1.7 | 5.2/0.9 | 97.4 | | | | 1:3 |
| 3 - Fluorogel 9:1 | | | | 0.74/0.62 | 13.2/2.2 | 97.18 | 9:1 |
| 4 - Fluorogel 6:1 | | | | 0.74/0.62 | 8.8/1.47 | 97.91 | 6:1 |
| 5 - Fluorogel 3:1 | | | | 0.74/0.62 | 4.4/0.73 | 98.65 | 3:1 |
| 6 - Fluorogel 1:1 | | | | 0.74/0.62 | 1.47/0.24 | 99.14 | 1:1 |
| 7 - Fluorogel 1:6 | | | | 4.45/3.71 | 1.47/0.24 | 96.05 | 1:6 |
| 8 - Fluorogel 1:9 | | | | 6.68/5.57 | 1.47/0.24 | 94.19 | 1:9 |
| 9 - Siligel 5:1 | 0.69/0.58 | 25.9/4.32 | 95.1 | | | | 5:1 |
| 10 - Siligel 3:1 | 0.69/0.58 | 15.6/2.59 | 96.83 | | | | 3:1 |
| 11 - Siligel 1:1 | 0.69/0.58 | 5.2/0.86 | 98.56 | | | | 1:1 |
| 12 - Siligel 1:5 | 3.45/2.9 | 5.2/0.86 | 96.24 | | | | 1:5 |

Please note that in respect to the initial and final concentrations in the above table, these have been provided for Sil—NCO, Sil—NH, NCO—PFPE, and bPEI only. That is to say, the initial concentrations of the Sil—NCO and Sil—NH are their initial concentrations in the silicone oil before mixing together, with the final concentrations depicting their concentrations after mixing. Equally, the NCO-PFPE and bPEI initial concentrations are their concentrations in the OH-PFPE oil before mixing, whereas their final concentrations depict their concentrations after mixing. For the avoidance of doubt, the concentrations of silicone oil and OH-PFPE oil provided are their final concentrations after mixing both solutions together.

### X-ray Photoelectron Spectroscopy

The unlubricated variations of the siligel and fluorogel coatings were deposited on glass slides for XPS (x-ray Photoelectron Spectroscopy) examination at the Materials Characterization and Preparation Facility (MCPF) Hong Kong University of Science and Technology (HKUST) MCPF-HKUST. XPS was performed with a Kratos Axis Ultra DLD multi-technique surface analysis system with AI mono anode (150W) at 1eV steps. The resulting spectra were analysed and peak fitted with CasaXPS (version 2.3.23).

### Fourier-Transform Infrared Spectroscopy

Unlubricated siligel and fluorogel coatings were examined via micro-ATR (micro-attenuated total reflectance) Fourier Transformed Infrared (FTIR) spectroscopy by the Materials Characterization and Preparation Facility (MCPF) at Hong Kong University of Science and Technology (HKUST). The samples were coated in a glass slide and examined with a Vertex Hyperion 1000 (Bruker) FTIR spectrometer (30 μm spot size). The resulting spectra was analysed to determine the coating specific chemical groups using the ‘DigiLab Resolutions pro 4’ software.

### X-ray Photoelectron Spectroscopy and Fourier-Transform Infrared Spectroscopy Results

The unlubricated Fluorogel and Siligel coatings were characterised via XPS and FTIR to determine the chemical properties. The XPS spectra were fairly consistent across the different ratio coatings, showing several strong peaks correlating to fluorine, carbon, nitrogen, and oxygen. The atomic concentration % of the various coatings were found to follow a general trend (table 2).

TABLE 2
Unlubricated Fluorogel XPS elemental composition

| | At % | | | | | | |
|---|---|---|---|---|---|---|---|
| Element | 9:1 | 6:1 | 3:1 | 1:1 | 1:3 | 1:6 | 1:9 |
| F | 30.0 ± 1.5 | 30.2 ± 1.5 | 32.6 ± 1.6 | 37.4 ± 1.9 | 40.3 ± 2.5 | 43.5 ± 2.2 | 46.0 ± 2.3 |
| O | 11.5 ± 0.6 | 14.6 ± 0.7 | 17.4 ± 0.9 | 15.2 ± 0.8 | 17.8 ± 0.9 | 15.2 ± 0.8 | 15.3 ± 0.8 |
| N | 13.3 ± 0.7 | 10.5 ± 0.5 | 6.9 ± 0.4 | 6.4 ± 0.3 | 1.7 ± 0.2 | 3.1 ± 0.3 | 2.4 ± 0.2 |
| C | 44.9 ± 2.2 | 44.8 ± 2.2 | 43.2 ± 2.2 | 40.3 ± 2 | 40.2 ± 2.1 | 38.2 ± 1.9 | 36.2 ± 1.8 |

The fluorine at % was found to be around 30 at % in the 9:1 and 6:1 inverse coatings and increases to a plateau in 1:3, 1:6, and 1:9 coatings. Likewise, the carbon at% decreases slightly as the ratio moves from 9:1 to 1:9. These can both be attributed to the change in coating composition, as the PFPE-NCO is a carbon backbone with fluorine functional groups while bPEI is mostly carbon with amine functional groups. Thus, increasing the proportions of PFPE-NCO will increase fluorine and lower the carbon slightly. Nitrogen was also found to decrease proportionally to the bPEI and can be attributed to the removal of excess NH₂ groups. Oxygen remains mostly consistent across the various coatings, which can be attributed to the carboxylic and urea groups in addition to atmospheric absorption. The C1s spectra were representative of the typical PFPE polymer, possessing two distinct peak regions (284-288 and 291-297), with intensity additions from the bPEI. The first region was fitted with three curves representing the C—C/C—H (284.8eV), C—O/C—N (286eV), and O—C═O/C═O (288eV) groups. The second region was associated with the carbon-fluorine bonding, namely the CF₂-CF₂ (292.4 eV), CF₂—O (293.9 eV), and the O—CF₂—O (295 eV). The XPS of 1:9, 1:3, and 1:9 show an increase CF signal strength (290-295 eV) in proportion to the C1s (284-289 eV), further supporting the wide scan change in composition.

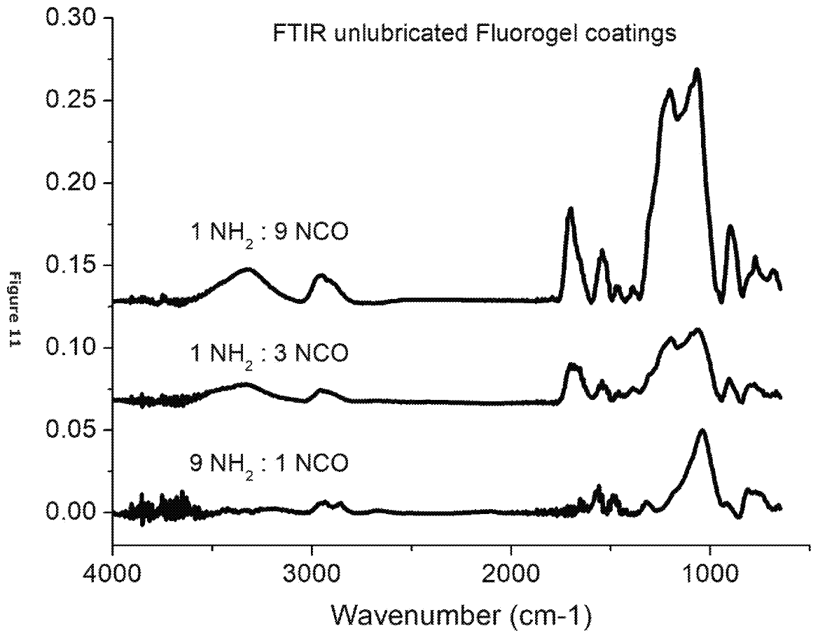

The FTIR spectra demonstrated several peaks associated with the fluorinated polymer nature of the coatings, after the subtraction of the glass substrate (FIG. 11). The broad stretch from 3550-3100 is strongly associated with OH bond, which could be a result of entrapped or residual EtOH from the synthesis. The 3000-2850 cm⁻¹ can be attributed to CH vibrations, while the peaks between 1750-1600 cm⁻¹ are comprised of various C═O from amide, ester, and urea bonds which are present in the PFPE end terminals, as well as cross-linking between the NCO and NH terminal groups. The isocyanate stretch at the 2270-2250 region is absent in our spectra, supporting the polyurea cross-linking. The left-side of the strong peak centred around 1100-1400cm⁻¹ can be primarily attributed to the C—F bond which is consistent with the significant reduction observed in the 9:1 spectrum when compared to the 1:1 and 1:9 ratio coatings. Overall, the various coatings are consistent with the expected FTIR based on the molar ratios, and previous PFPE and polyurea polymers.

The elemental composition of the unlubricated Siligel was found to be relatively uniform within error across the various molar ratio coatings. The XPS showed carbon was ranged between 42-48 at %, oxygen from 22-29 at %, and silicon between 24-30 at %, with minor contributions from nitrogen (0.5-1.5%). The detailed Si2p and C1s peaks showed the expected fittings for silicone. The Si2p stretch, located between 101-105 eV, were fitted with three curves consistent with a silicon-oxygen polymer backbone highly conjugated with CH3 groups: Si—C at 101.2 eV, Si—O—C/Si—O at 102.2 eV, and SiO2 (potential from the glass substrate) around 103.3 eV. These fittings were present in approximately the same proportions across all coatings, as shown by the Si 2p for 5:1 and 1:5, seen in FIG. 1 a and b. The C1s peak was centered around 285 eV tailing off to 288 eV, indicating a predominate C13 C/C—H bonds from the abundant methyl side groups and the Sil—NCO cyclohexane groups, with smaller contributions from the C—O and C═O groups at the NH—NCO crosslinking terminals, seen in FIGS. 1c and d.

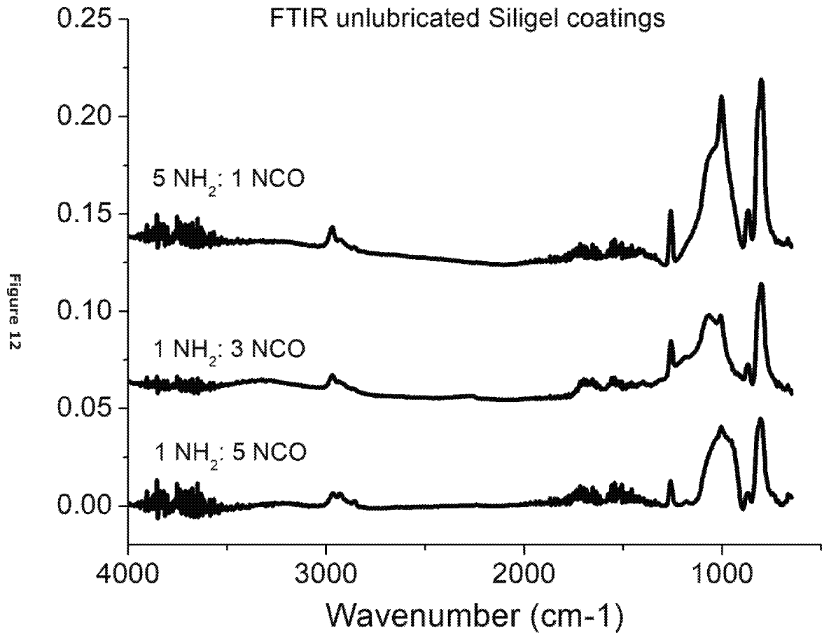

The FTIR analysis of the unlubricated Siligel from 500-4000 cm−1 demonstrated a series of strong peaks after the spectral subtraction of glass, seen in FIG. 12. There is a strong stretch from approximately 3500-3000 cm−1 which can be attributed to potential OH residue from the EtOH solvent while the neighboring sharp peak around 3000-2850 is associated with symmetric and asymmetric CH stretches, such as those found in the conjugated benzene structures of Sil—NCO. There is a small sharp peak at 2300-2250, which is derived from N═C═O bond vibrations which would indicate the presence of unreacted Sil—NCO chains, but the stronger presence of ester and amide C═O peaks at 1800-1650 demonstrated that the crosslinking reaction has been carried out. Additionally, the thin sharp peak at 1250 also correlates will to a Carbon-Oxygen bond, which would be the resulting structure from the Siligel's crosslinking reaction. The stretch from approx. 1600-1400 can be attributed to NH and C═C groups while the strong peak from 1150-1050 can be assigned to C—O bonds from an aliphatic ether or secondary alcohols. The peaks below can be derived from C═C and numerous CH groups in the chemical structures. Overall, the physico-chemical properties of the siligel coatings fit the expectations derived from the silicone precursors. Both the Sil—NCO and Sil—NH reagents are silicon backbones with CH3 groups and isocyanate or amine functional ends, respectively. The FTIR and XPS shows little chemical difference between the 5:1-1:5 ratios of unlubricated siligels (compositions 2, and 9-12 in Table 1) as a result. Therefore, the contact and sliding angles were examined to determine the optimal conditions.

### Contact and Sliding Angles

The omniphobicity of the 1-step lubricated fluorogel and siligel coatings were examined using RO (reverse osmosis) water, Canola oil, and Diiodomethane (MeI). The contact angles (CAs) and sliding angles (SAs) were measured on a KrLiss drop shape analyzer with tilting stand and analysed with the KrLiss Advance analytical software. Static contact angles (5 μL) were fitted to the Young-Laplace fitting, while sliding angles (SAs) (20 μL) were fitted to the ‘Ellipse (tangent −1)’ function. After the measurements were taken (n≥6), the surfaces were washed twice in excess absolute ethanol and allowed to recover overnight.

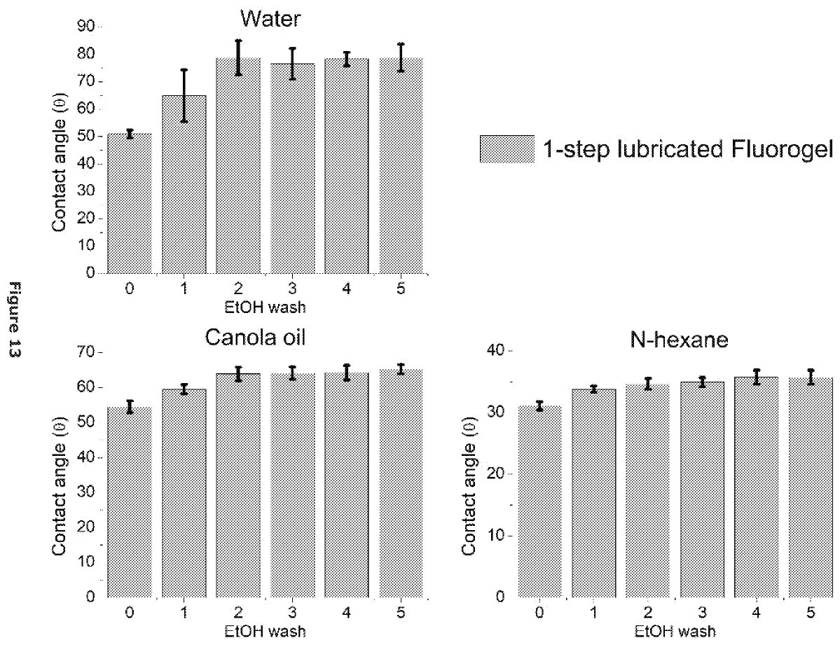

The contact angles (CAs) on the 1-step fluorogel coatings (compositions 1, and 3-8 in Table 1) were found to be approximately equivalent across the compositions and found to increase proportionally to the number of washes (FIG. 13). Water CAs demonstrated the most pronounced increase from an initial ˜50° to a stabilised ˜75-80° by 3× washes. Canola oil CAs increased from 50-55° to 60-65° after 2× washes with the 1:6 ratio coating stabilised around 70°. The hexane CAs were largely unaffected by the wash-recovery cycles, with an increase from ˜30° to ˜36°. The examined unlubricated coatings demonstrated almost identical CAs, with a slightly elevated n-hexane measurement of approximately 40°.

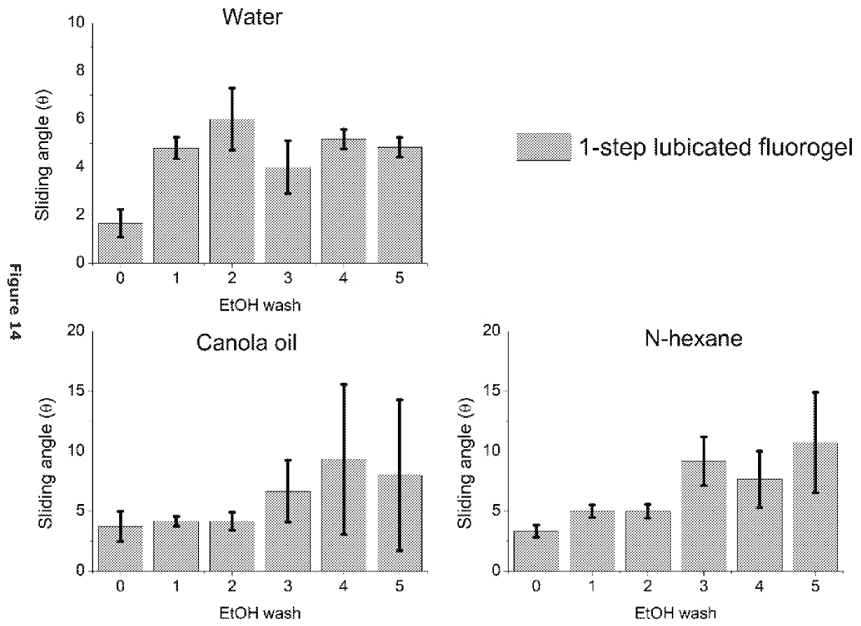

Considerable differences in sliding angle (SAs) behaviour were observed between the molar ratios (FIG. 14). The 1:1, 1:3, and 1:9 coatings (Compositions 6, 1, 8, respectively in Table 1) were shown to have initial SAs<5° before gradually increasing but remaining around or below 10° on average after the 5 washes. The 1:6 ratio coating (Composition 7 in Table 1) was found to have poorer sliding capacity with angles of 15° after 1-2× washes and 25-30° after 4× washes. The inverted ratio coating 6:1 (Composition 4 in Table 1) was also found to have larger and more variable sliding angles than the 3:1 and 9:1 ratios (compositions 5 and 3 in Table 1 respectively). However, all bPEI majority ratio films demonstrated more initial variability in wetting behaviour due to the presence of a white film on the surface believed to be produced by excess reagents. The localised white films would reduce contact angles or induce surface wetting by the probe liquid but were displaced after 1-2× EtOH washing, restoring a complete OH-PFPE layer.

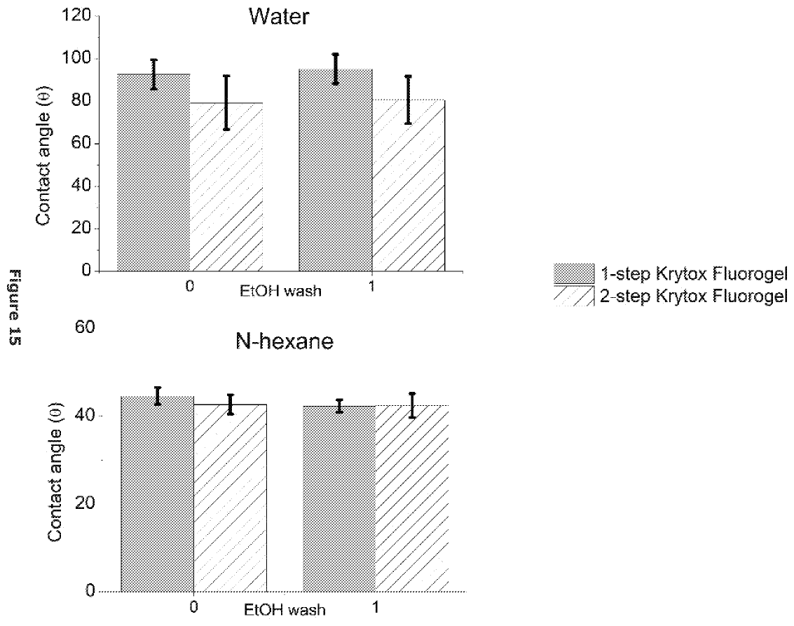

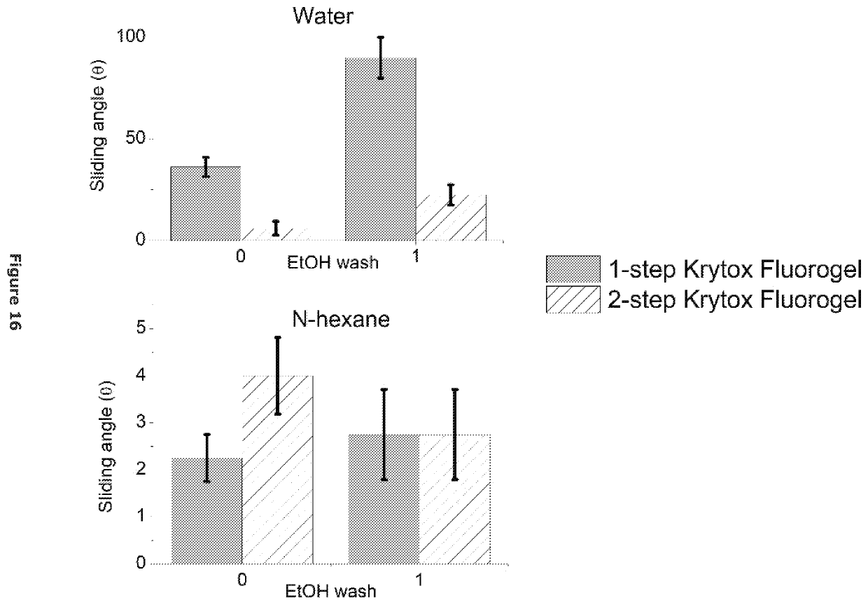

The 1:3 ratio PFPE-OH lubricated fluorogel was also compared to a Krytox GPL 103 lubricated fluorogel at Ox washes. The Krytox lubricated fluorogels were produced by the 1-step synthesis and a more traditional 2-step method of post-synthesis lubricant infusion. The Krytox lubricated fluorogels performed better than the PFPE-OH fluorogels in terms of contact angles with water and n-hexane CAs of 93°±7° and 44°±2° for the 1-step, and 79°±13° and 43°±3° for the 2-step (FIG. 15). However, the krytox performed poorer in the sliding angles with initial water and hexane SAs of 36°±5° and 2.0°±0.5° for the 1-step and 4°±1° and 6°±3° for the 2-step. Successive washes in EtOH showed the n-hexane sliding angle remained around 4-6° for both Krytox infused coatings. The water SA measurements, however, showed an increase from approx. 6° to 22°±5° in the 2-step Krtox after lx EtOH wash, and the transition to water pinning for the 1-step coating (FIG. 16).

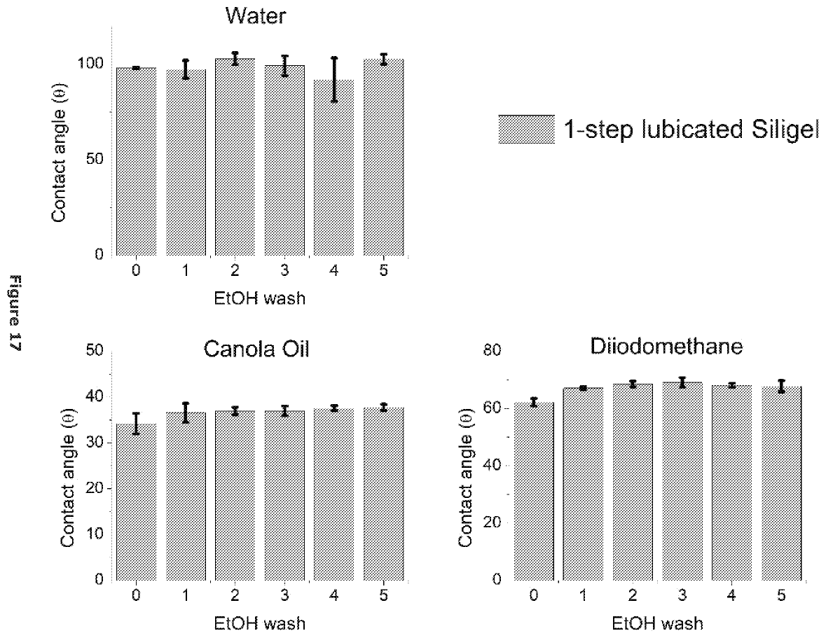

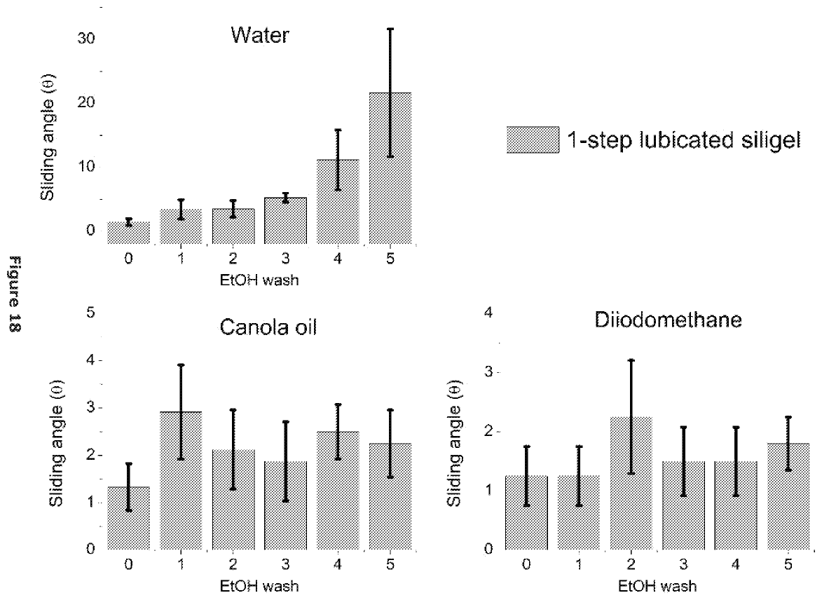

The lubricated 1-step Siligel coatings with molar ratios of 5:1-1:5 (see compositions 2, 9-12 from Table 1) were probed with water, diiodomethane (MeI), and Canola oil to represent a variety of polar and dispersive conditions. The contact angles were found to remain constant within variation regardless of the number of EtOH washes and molar ratio composition. Water CAs were found to be between 90°-100°, Canola oil around 37°-40°, and MeI fluctuated around 65°-70°, which are consistent with previous publications (FIG. 17). Therefore, the sliding angles were examined to determine the optimal coating conditions (FIG. 2). The canola and MeI droplets (20 μL) were found to slide at θ≥5° on average regardless of coating composition. However, the water sliding angles demonstrated a clear difference between the ratios. The water SAs were approximately follow the same trends across final compositions 2 and 9-12 of Table 1 (FIG. 18). However, there subtle variations in water sliding behaviours for the gradient of WSA increase between the 5:1, 1:5, and other coatings. With the 3:1-1:3 range, the lowest water sliding angles were found on the 1:3 ratio coating for each respective point, despite the large variation by the 5th pure ethanol wash.

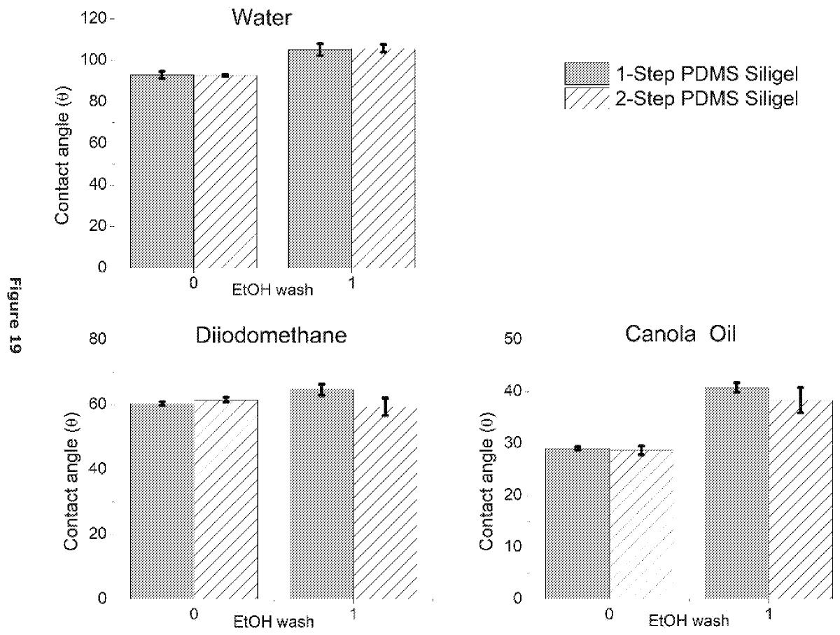

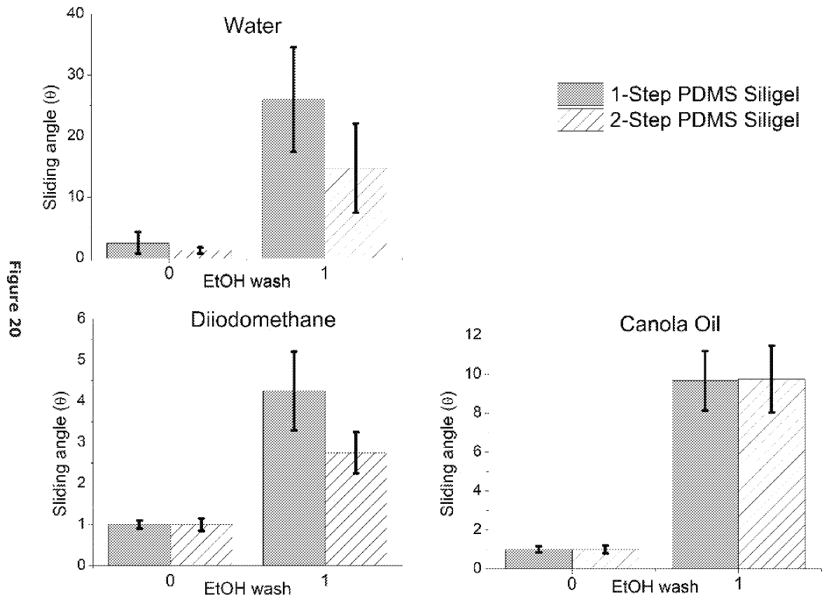

Hydroxy terminated liquid PDMS (Polydimethylsiloxane) was substituted for the Silicone oil in the 1:3 siligel coating (Composition 2 in Table 1) via the 1-step and 2-step methods. The 1-step and 2-step PDMS lubricated Siligel coatings were found to have 0× washing contact angles around 93° for water, 60-62° for Mel, and 29° for Canola oil, and lx wash CAs around 105° for water, 60-64° for Mel, and 40° for Canola (FIG. 19). The sliding angles were used to distinguish between the coatings, as previously. The 1-step and 2-step PDMS Siligels started with SAs of around 1° for all test liquids due to the fully-lubricated surface. After washing, the 1-step coatings produced Sliding angles of 20±5°, 4±1°, and 9.6±1.5° for water, Mel, and Canola oil, respectively, while the 2-step coating performed slightly better with SAs of 15±7° for water, 2.8±0.5° for MeI, and 9.8±1.7° for Canola oil (FIG. 20). Thus, the PDMS lubricated coatings did not perform as well compared to the Silicone oil equivalents.

The complex liquids of honey, tomato ketchup, yogurt, and jam were used to further probe the omniphobic properties of the lubricated Fluorogel and siligel coatings, and further explore their capacity for food storage. Glass slides were coated as described in examples 1-3, following compositions 1 and 2 from Table 1. The substrates were elevated to approx. and considerable proportions of the food stuffs were deposited at the top of the slides. The recorded sliding speed for each food-coating combination demonstrates that the siligel was able to sliding the test liquids quicker and cleaner than the fluorogel and uncoated glass control, even after rinsing with water. The coatings were also tested on the internal surfaces of PET bottles, which were filled to ⅓ with the test foodstuffs. The same trends were observed in the bottles, with the foodstuffs sliding off the siligel while spreading across the fluorogel and uncoated glass surfaces. The bottles demonstrated a gradual loss of sliding speed but retained potential for numerous washes in water and EtOH. The contact/sliding angles of canola oil and foodstuffs, in combination with the inexpensive reagents, establish biocompatibility, and easy, rapid reaction, suggest that the lubricated siligels have a strong potential application in the food processing, storage, and transportation markets. The sliding times for foodstuffs can be seen in Table 3 below:

TABLE 3
Sliding information for examined Foodstuffs rate

| | Inclination | | Time | distance | sliding rate | |
|---|---|---|---|---|---|---|
| Food | (θ) | coating | (Sec) | (cm) | (cm/sec) | notes |
| Jam | 25 | Uncoated | 110 | 0 | 0 | stayed fixed in |
| | | | | | | place |
| | | Fluorogel | 45 | 3 | 0.067 | Slowly edged |
| | | | | | | down glass |
| | | Siligel | 50 | 7 | 0.14 | slid off the |
| | | | | | | surface |
| Honey | 25 | Uncoated | 55 | 7 | 0.13 | Spread over the |
| | | | | | | glass |
| | | Fluorogel | 50 | 6.5 | 0.13 | was not |
| | | | | | | completely |
| | | | | | | clean like the |
| | | | | | | silicone oil |
| | | Siligel | 23 | 7 | 0.3 | clean sliding |
| ketchup | 25 | Uncoated | 120 | 3 | 0.025 | slides under |
| | | | | | | sheer forces |
| | | Fluorogel | 140 | 7 | 0.05 | Will slide with |
| | | | | | | lubrication but |
| | | | | | | eventually |
| | | | | | | catches and |
| | | | | | | sheers |
| | | Siligel | 60 | 6 | 0.1 | clean sliding |
| yogurt | 39 | Uncoated | 110 | 3 | 0.027 | sticks to the |
| | | | | | | glass |
| | | Fluorogel | 90 | 7 | 0.078 | spread across |
| | | | | | | the glass |
| | | Siligel | 40 | 7 | 0.175 | clean sliding |
| | | | | | | off glass |

### Cell Culture and Proliferation Assay

MDA-MB-468 and HEK-293 cell lines were used for proliferation assays and accompanying miscopy images. The cells were cultured as per standard protocol, before seeding on 48 well plates (Corning). Briefly, the MDA and HEK cell lines were expanded in 5cm diameter Petri Dishes (Corning) with RPMI1640 media (10% Bovine Serum Albumin, 1% Penicillin-Streptomycin) until 80-90% confluence. The cells were washed in a Phosphate buffer solution (PBS)(Gibco) and tripsinised at 35° C. and 5% CO₂ until detached. The cell suspension was spun down at 300×g for 3 min and resuspended in media before seeding in the 48 well plates at 1000 and 5000 cells for MDA and HEK, respectively.

The proliferation of MDA and HEK cells were examined with cell counting kit 8 (CCK-8) (Yeasen, China). The well plates were coated and treated for two minutes with the Fluorogel and Siligel (lubricated and unlubricated) coatings then allowed to drain overnight before UV sterilisation for 30 minutes. The cells were then measured at day 1, 3, and 7 with 10% (v/v) CCK-8/cell media solution. The MDA and HEK cells were incubated in CCK-8 solution for 4 hours alongside a no-cell blank control and 100 mL aliquots were transferred to a clear 96 well plate. The absorption was read at 450 nm using a SpectraMax M2 (Molecular Devices) plate reader. Images of the omniphobic coatings and cell growth were recorded with a Nikon Eclipse Ts2 light microscope and ChineTek Scientific microscope camera.

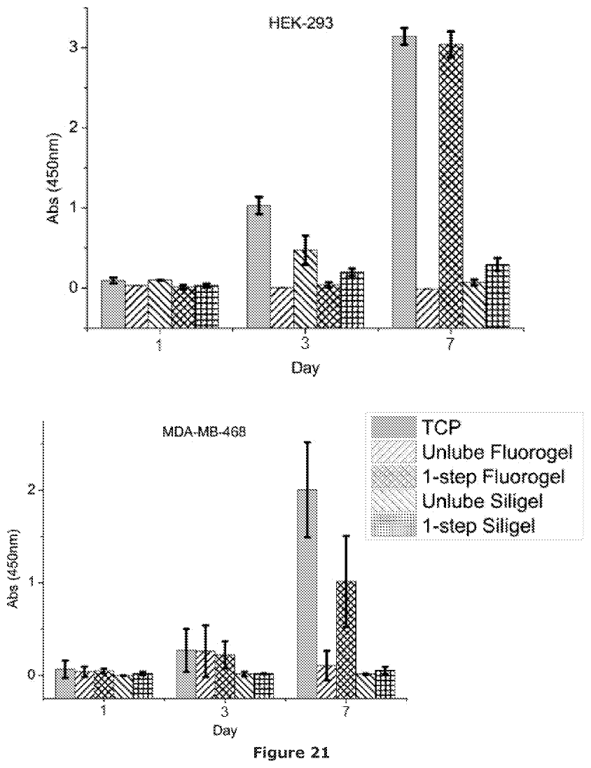

The proliferation and spreading behaviours of the MDA, and HEK cells on the various surfaces were examined via CCK-8 assay and microscopy at day 1, 3 and 7 post seeding (FIG. 21). The CCK-8 assay showed the standard growth curve for both cell lines on the untreated TCP (tissue culture plastic) surfaces. The Fluoro and Siligel unlubricated coatings and the 1-step siligel coatings demonstrated little to no cellular growth over the 7 days. However, the 1-step lubricated fluorogel demonstrated cellular proliferation at half and equivalent levels as the TCP for MDA and HEK cells, respectively. Microscopy images confirmed the CCK-8 assay results. The TCP and 1-step Fluorogel day 1 images had considerably spread cells across the surface, with cell elongation indicating attachment to the surface when observed under 100× magnification. The few HEK and MDA cells that were observed on the 1-step lubricated siligel and unlubricated Siligel were found to be rounded in shape, indicating a lack for focal adhesion sites. Cells were also observed to be floating in suspension indicative of apoptosis. The day 3 and day 7 images followed this trend, with the TCP and 1-step lubricated fluorogel developing monolayers across the wells, while the unlubricated fluorogel variant had essentially no cellular growth. The 1-step lubricated siligel had the occasional cell cluster with the morphology being rounded and semi-detached.

The difference in cellular proliferation between the fluorogel and siligel, lubricated and unlubricated, can be derived from the omniphobic nature of the respective coatings. The lubricated fluorogel was the only coating to have enough attached cells to start proliferation. The atypically ‘philic’ nature of the fluorogel, starting at 50° for the 0× washed coating used in the cell tests, could allow for the cells to become more established under the static conditions of cell seeding. In contrast, the unlubricated fluorogel coatings produced essentially no cellular proliferation.

In the case for the 1-step and unlubricated siligel coatings, it appears that the presence of silicone oil has little effect on the cellular behaviours. Both coatings have a strongly inert chemical composition and Ox wash WCAs approx. 100°, and thus, would discourage cell establishment. The 1-step siligel does have a slightly elevated CCK-8 signal by day 7, potentially due to the smoother surface condition provided by the lubricating oil as solvent in the deposition process.

### Discussion of Results

The lubricated Siligel coatings, specifically the 1:3 ratio, demonstrated comparable wetting properties and cellular behaviours to established approaches, while addressing some limitations around for scalable synthesis.

The contact and sliding angles of the 1:3 ratio 1-step siligel fall within the standard range of other silicone-based SLIPS; WCA values approximating 100°, lubricated sliding angles of approximately 3°, and lubricant depleted SAs of 10°. The siligel was also able to slide a variety of complex solutions/emulsions, i.e. tomato ketchup, honey, yogurt, with little to no traces remaining on the coatings for multiple washes in water and pure EtOH. The surface free energy/ surface tension of the siligel coatings were estimated with the standard OWRK model to match the reported surface tension of n-hexadecane (27 mN/m) which would explain the wetting interactions between the siligel and liquid. Canola oil, another highly polar liquids with reported surface tensions of 30-34 mN/m, presented little issue for the coatings.

1. A composition comprising:
a cross-linkable hydrophobic polymer component comprising at least three nucleophilic groups;
a cross-linking hydrophobic polymer agent comprising at least two electrophilic groups that cross-links with the cross-linkable component under reaction enabling conditions; and
a hydrophobic polymer lubricant component;
wherein the cross-linkable hydrophobic polymer component and the cross-linking hydrophobic agent are present in the composition in an amount so as to provide a molar ratio of nucleophilic groups to electrophilic groups of 9:1 to 1:9.

2. The composition according to claim 1, wherein the cross-linkable hydrophobic polymer component and the cross-linking hydrophobic polymer agent are present in the composition in an amount so as to provide a molar ratio of nucleophilic groups to electrophilic groups of 9:1 to 1:9, such as 5:1 to 1:5, or 3:1 to 1:3.

3. The composition according to claim 1 or claim 2, wherein the cross-linkable hydrophobic polymer component comprises from 3 to 10 nucleophilic groups, such as from 3 to 5 nucleophilic groups, for example 3 nucleophilic groups.

4. The composition according to any preceding claim, wherein the cross-linking hydrophobic polymer agent comprises from 2 to 5 electrophilic groups, such as 2 to 3 electrophilic groups, for example 2 electrophilic groups.

5. The composition according any preceding claim, wherein the nucleophilic groups on the cross-linkable hydrophobic polymer component are amine groups.

6. The composition according to any preceding claim, wherein the electrophilic groups on the cross-linking hydrophobic polymer agent are isocyanate groups.

7. The composition according to any preceding claim, wherein the cross-linkable hydrophobic polymer component has a molecular weight of from 5,000 to 25,000, for example from 5,000 to 15,000, such as from 10,000 to 13,000.

8. The composition according to any preceding claim, wherein the cross-linking hydrophobic polymer agent has a molecular weight of from 2,000 to 10,000, such as from 4,000 to 9,000.

9. The composition according to any preceding claim, wherein the cross-linkable hydrophobic polymer component has a viscosity at 25° C. of from 100 to 1000 cps, such as from 300 to 700 cps.

10. The composition according to any preceding claim, wherein the cross-linking hydrophobic polymer agent has a viscosity at 25° C. of from 30 to 75,000 cps, for example from 30 to 50,000 cps, such as from 100 to 20,000 cps, for example from 500 to 5000 cps, such as from 1000 to 3500 cps.

11. The composition according to any preceding claim, wherein the cross-linkable hydrophobic polymer component and/or the cross-linking hydrophobic polymer agent is a silicone, a perfluoro poly(ethers) or a derivative thereof.

12. The composition according to any preceding claim, wherein the hydrophobic polymer lubricant is selected from the list consisting of polyols, silicone oils, perfluoro poly(ethers), and mixtures thereof.

13. The composition according to any preceding claim, wherein the cross-linkable hydrophobic polymer component is present in the composition in an amount of from 0.01 to 10 wt. %, such as from 0.03 to 10 wt. %, for example from 0.1 to 5 wt. %, such as from 0.2 to 5 wt. %, for example 0.2 to 1 wt. %.

14. The composition according to any preceding claim, wherein the cross-linking hydrophobic polymer agent is present in the composition in an amount of from 0.1 to 10 wt. %, such as from 0.2 to 8 wt. %, for example from 0.5 to 6 wt. %, such as from 1 to 2 wt. %.

15. The composition according to any preceding claim, wherein the hydrophobic polymer lubricant component is present in the composition in an amount of from about 70 wt. % to about 99.9 wt. %, such as from about 80 wt. % to about 99.5 wt. %, for example from 85 to 99.5 wt. %, such as from 90 to 99.2 wt. %, for example from 96 to 99 wt. %.

16. A coated article comprising:
(c) a substrate; and
(d) a composition according to any one of claims 1 to 15 coated on a surface of the substrate.

17. The coated article according to claim 16, wherein the substrate is selected from the group consisting of plastics, glass, metal and ceramics.

18. The coated according to claim 16 or claim 17, wherein the composition coated on the surface of the substrate has a thickness of from 50nm to 1mm.

19. A method of preparing a coated article comprising the steps of:
providing an article comprising a substrate and at least one surface; and
applying a composition according to any one of claims 1 to 15 to the surface of the substrate, wherein the electrophilic groups on the cross-linking hydrophobic polymer agent react with the nucleophilic groups of the cross-linkable hydrophobic polymer component to provide a cross-linked coating.

20. A method according to claim 19, wherein the composition is preparing by:
providing a first solution comprising the cross-linkable hydrophobic polymer component in the hydrophobic polymer lubricant;
providing a second solution comprising the cross-linking hydrophobic polymer agent in the hydrophobic polymer lubricant; and
mixing the first and second solutions prior to applying to the surface of the substrate.

21. The method according to claim 20, wherein the first and second solution are homogenized before applying to the surface of the substrate.

22. The method according to claim 20 or claim 21, wherein the composition is applied to the surface of the substrate within 300 seconds of mixing the first and second solutions.

23. The method according to any one of claims 20 to 22, wherein in the first solution the cross-linkable hydrophobic polymer component is present in an amount of from to 40 wt. %, such as from 0.5 to 37 wt. %, for example from 1 to 10 wt. %, such as from 1 to 6 wt. % and wherein the hydrophobic polymer lubricant is present in an amount of from 60 to 99.9 wt. %, such as from 63 wt. % to 99.5 wt. %, for example from 90 to 99 wt. %, such as from 94 to 99 wt. %.

24. The method according to any one of claims 20 to 23, wherein in the second solution the cross-linking hydrophobic polymer agent is present in an amount of from 0.1 to wt. %, for example from 0.5 to 15 wt. %, such as from 1 to 5 wt. %, for example from 1 to 3 wt. %, and wherein the hydrophobic polymer lubricant is present in an amount of from 80 to 99.9 wt. %, for example from 85 wt. % to 99.5 wt. %, such as from 95 to 99 wt. %, for example from 97 to 99 wt. %.

25. The method according to any one of claims 19 to 24, wherein the composition is applied to the surface of the substrate at a temperature of from 0° C. to 60° C., for example from about 10° C. to 50° C., such as from 15° C. to 40° C.

26. A kit-of-parts comprising:
(a) a first solution comprising a cross-linkable hydrophobic polymer component in a hydrophobic polymer lubricant, wherein the cross-linkable hydrophobic polymer component comprises at least three nucleophilic groups; and
(b) a second solution comprising a cross-linking hydrophobic polymer agent in a hydrophobic polymer lubricant, wherein the cross-linking hydrophobic polymer agent comprises at least two electrophilic groups,
wherein the cross-linkable hydrophobic polymer component is present in the first solution and the cross-linking hydrophobic agent is present in the second solution in an amount so as to provide a molar ratio of nucleophilic groups to electrophilic groups of 9:1 to 1:9.

27. Use of a composition according to any one of claims 1 to 15 for coating a substrate.

28. A composition prepared by the method according to any one of claims 19 to 25.
